(19) United States
(12) Patent Application Publication
(10) Pub. No.: US 2025/0161821 A1
(43) Pub. Date: May 22, 2025

(54) METHOD AND APPARATUS FOR PROVIDING GAME SERVICE

(71) Applicant: NEXON KOREA CORPORATION, Seongnam-si (KR)

(72) Inventors: Jung Hoon HAN, Seongnam-si (KR); Dong Sun KIM, Seongnam-si (KR); Jeong Soo KIM, Seongnam-si (KR)

(21) Appl. No.: 18/955,524

(22) Filed: Nov. 21, 2024

(30) Foreign Application Priority Data
Nov. 21, 2023 (KR) 10-2023-0162713

(51) Int. Cl. A63F 13/79; A63F 13/533

(52) U.S. Cl. CPC A63F 13/79; A63F 13/533; A63F 2300/575

(57) ABSTRACT

A method of providing a game service, by a game providing apparatus, is disclosed. The method includes transferring the item from an inventory of the user to the illustrated guide pool, based on a store request for storing an item retained by a user in an illustrated guide pool. The method includes providing a reward to the user as the item is transferred to the illustrated guide pool. The method includes transferring the item from the illustrated guide pool to the inventory of the user, based on a return request for returning the item stored in the illustrated guide pool to the inventory. The method includes retrieving the reward that has been provided to the user as the item is transferred to the inventory of the user.

### CROSS-REFERENCE TO RELATED APPLICATION

This application is based on and claims priority under 35 U.S.C. § 119 to Korean Patent Application No. 10-2023-0162713, filed on Nov. 21, 2023, in the Korean Intellectual Property Office, the disclosure of which is incorporated by reference herein in its entirety.

### BACKGROUND

### Technical Field

The disclosure relates to a method and apparatus for providing a game service. In particular, the disclosure relates to a method and apparatus for providing various game services regarding a user's items transferred from an inventory to an illustrated guide pool.

### Description of the Related Art

Recently, many games of various genres have been developed, which have led to an explosive increase of the number of users. As games of various genres have been developed and the performance of devices for enjoying games has improved, games have emerged as a mainstream hobby.

In the game industry, various systems have been introduced to induce users to participate in a game and to allow the users to try new tactics while playing games. Accordingly, users' interests in the game may be prompted. In particular, a user may establish various game strategies by using game items.

For example, the user may collect game items and may receive certain rewards for the collection of items. By introducing a system related to the collection of items, a value of the item may be improved, and the user may be granted a new challenge.

### BRIEF SUMMARY

The present disclosure provides a method and apparatus for providing a game service for diversifying methods of utilizing game items.

Additional aspects will be set forth in part in the description which follows and, in part, will be apparent from the description, or may be learned by practice of the presented embodiments of the disclosure.

According to an embodiment, a method of providing a game service, by a game providing apparatus, includes, based on a store request for storing an item retained by a user in an illustrated guide pool, transferring the item from an inventory of the user to the illustrated guide pool, providing a reward to the user as the item is transferred to the illustrated guide pool, based on a return request for returning the item stored in the illustrated guide pool to the inventory, transferring the item from the illustrated guide pool to the inventory of the user, and retrieving the reward that has been provided to the user as the item is transferred to the inventory of the user.

According to an embodiment of the present disclosure, a game providing apparatus includes a memory storing instructions, and at least one processor functionally connected to the memory and configured to execute the instructions, wherein the at least one processor is configured to execute the instructions to, based on a store request for storing an item retained by a user in an illustrated guide pool, transfer the item from an inventory of the user to the illustrated guide pool, provide a reward to the user as the item is transferred to the illustrated guide pool, based on a return request for returning the item stored in the illustrated guide pool to the inventory, transfer the item from the illustrated guide pool to the inventory of the user, and retrieve the reward that has been provided to the user as the item is transferred to the inventory of the user.

According to an embodiment of the present disclosure, a server includes a memory storing instructions, and at least one processor functionally connected to the memory and configured to execute the instructions, wherein the at least one processor is configured to execute the instructions to, based on a store request for storing an item retained by a user in an illustrated guide pool, transfer the item from an inventory of the user to the illustrated guide pool, provide a reward to the user as the item is transferred to the illustrated guide pool, based on a return request for returning the item stored in the illustrated guide pool to the inventory, transfer the item from the illustrated guide pool to the inventory of the user, and retrieve the reward that has been provided to the user as the item is transferred to the inventory of the user.

According to an embodiment of the present disclosure, a user terminal includes a memory storing instructions, and at least one processor functionally connected to the memory and configured to execute the instructions, wherein the at least one processor is configured to execute the instructions to, based on a store request for storing an item retained by a user in an illustrated guide pool, transfer the item from an inventory of the user to the illustrated guide pool, provide a reward to the user as the item is transferred to the illustrated guide pool, based on a return request for returning the item stored in the illustrated guide pool to the inventory, transfer the item from the illustrated guide pool to the inventory of the user, and retrieve the reward that has been provided to the user as the item is transferred to the inventory of the user.

In an embodiment, a computer-readable recording medium having recorded thereon a program for executing, on a computer, a method of providing a game service, by a game providing apparatus, including, based on a store request for storing an item retained by a user in an illustrated guide pool, transferring the item from an inventory of the user to the illustrated guide pool, providing a reward to the user as the item is transferred to the illustrated guide pool, based on a return request for returning the item stored in the illustrated guide pool to the inventory, transferring the item from the illustrated guide pool to the inventory of the user, and retrieving the reward that has been provided to the user as the item is transferred to the inventory of the user.

In an embodiment, a method, performed by a game providing apparatus, of providing a game service, the method includes, based on a store request for storing an item retained by a user in an illustrated guide pool, transferring the item from an inventory of the user to the illustrated guide pool, providing a reward to the user as the item is transferred to the illustrated guide pool, and based on that all of items included in a preset item set are stored in the illustrated guide pool as the item is transferred to the illustrated guide pool, displaying a character of the user wearing a preset item set.

In an embodiment, a method, performed by a game providing apparatus, of providing a game service, the method includes based on a store request for storing a plurality of items retained by a user in an illustrated guide pool, transferring collectively the plurality of items from an inventory of the user to the illustrated guide pool, and providing a reward to the user as the plurality of items are collectively transferred to the illustrated guide pool.

### BRIEF DESCRIPTION OF THE SEVERAL VIEWS OF THE DRAWINGS

The above and other aspects, features, and advantages of certain embodiments of the disclosure will be more apparent from the following description taken in conjunction with the accompanying drawings, in which:

FIG. 1 is a diagram showing a game providing system including a server and a user terminal, according to various embodiments of the present disclosure;

FIG. 2 is a conceptual diagram for describing an operation of transferring items, according to an embodiment of the present disclosure;

FIG. 3 is a flowchart for describing a method of providing a game service, according to an embodiment of the present disclosure;

FIG. 4 is a diagram for describing an item set according to an embodiment of the present disclosure;

FIG. 5 is a diagram for describing an interface according to whether an item may be stored in an illustrated guide pool, according to an embodiment of the present disclosure;

FIG. 6 is a diagram for describing an interface for filtering general items and set items in an illustrated guide pool, according to an embodiment of the present disclosure;

FIG. 7 is a diagram for describing an interface for transferring a plurality of items from an inventory of a user to an illustrated guide pool, according to an embodiment of the present disclosure;

FIG. 8 is a diagram for describing an interface for transferring a plurality of items from an illustrated guide pool to an inventory of a user, according to an embodiment of the present disclosure;

FIG. 9 is a diagram for describing an interface for corresponding to a store request for storing items from an inventory of a user to an illustrated guide pool, according to an embodiment of the present disclosure;

FIG. 10 is a diagram for describing an interface for corresponding to a return request for returning items from an illustrated guide pool to an inventory of a user, according to an embodiment of the present disclosure;

FIG. 11 is a diagram for describing an interface for displaying a reward according to a level of an illustrated guide, according to an embodiment of the present disclosure;

FIG. 12 is a flowchart for describing a method of providing a game service, according to an embodiment of the present disclosure;

FIG. 13 is a flowchart for describing a method of providing a game service, according to an embodiment of the present disclosure;

FIG. 14 is a diagram for describing a detailed configuration of a game providing apparatus, according to an embodiment of the present disclosure;

FIG. 15 is a diagram for describing a detailed configuration of a server according to an embodiment of the present disclosure; and

FIG. 16 is a diagram for describing a detailed configuration of a user terminal according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, one or more embodiments of the present disclosure will be described in detail with reference to accompanying drawings. Also, a method of configuring and using an electronic apparatus according to an embodiment of the present disclosure will be described in detail with reference to the accompanying drawings. In the drawings, like reference numerals or symbols may denote like parts or components that perform substantially the same function.

Throughout the disclosure, the expression “at least one of a, b or c” indicates only a, only b, only c, both a and b, both a and c, both b and c, all of a, b, and c, or variations thereof. In addition, the expression “at least one of A and B” may have similar meanings. For instance, the expression “at least one of A and B” as used herein should be understood to include at least one of A, or at least one of B, or at least one of both A and B. This similarly applies to “at least one of A, B, and C” and so forth.

It will be understood that although the terms “first” and “second” are used herein to describe various elements, these elements should not be limited by these terms. Terms are only used to distinguish one element from other elements. For example, a second element may be referred to as a first element while not departing from the scope of the disclosure, and likewise, a first element may also be referred to as a second element. The term and/or includes a combination of a plurality of related described items or any one item among the plurality of related described items.

Also, the terms used in the present specification are merely used to describe particular embodiments, and are not intended to limit the present disclosure. An expression used in the singular encompasses the expression of the plural, unless it has a clearly different meaning in the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Throughout the specification, it will be understood that when an element is referred to as being “connected” to another element, it may be “directly connected” to the other element or “electrically connected” to the other element with intervening elements therebetween. It will be further understood that when a portion is referred to as “comprising” another component, the portion may not exclude another component but may further comprise another component unless the context states otherwise.

In addition, the terms such as “ . . . unit”, “module”, etc., provided herein indicates a unit performing at least one function or operation, and may be realized by hardware, software, or a combination of hardware and software. To be specific, the term “unit” or “module” as used herein may include any electrical circuitry, features, components, an assembly of electronic components, or the like. That is, “unit” or “module” may include any processor-based system including systems using microcontrollers, integrated circuits, chips, microchips, reduced instruction set computers (RISC), application specific integrated circuits (ASICs), field-programmable gate arrays (FPGAs), graphical processing units (GPUs), logic circuits, and any other circuit or processor capable of executing the various operations and functions described herein. The above examples are examples only, and are thus not intended to limit in any way the definition or meaning of the term “unit” or “module.” In some embodiments, the various units or modules described herein may be included in or otherwise implemented by processing circuitry such as a microprocessor, microcontroller, or the like.

Hereinafter, “game providing apparatus” may denote a game server, a user terminal, a game system including a game server and a user terminal, or an independent apparatus.

Hereinafter, in the present disclosure, that a server controls user terminal may denote that the server provides an output from the user terminal (all output devices in the user terminal, such as screen display, sound output, vibration output, lamp illumination, etc.) and data for the user terminal to perform certain operations, through a communication with the user terminal. The user terminal may control the output from the user termina by using data stored in advance, and is not limited to the above examples.

Hereinafter, in the present disclosure, sending/receiving information or data to/from a user (or user account) may include sending/receiving information or data to/from a device (or user terminal) corresponding to or linked with the user (or user account).

Hereinafter, a user, a player, a user account, and a gamer may have same meaning. In the present disclosure, it should be understood that a user terminal may denote a user, a player, a user account, a gamer, or a device used by them according to the context. In the present disclosure, it should be understood that the user, player, user, user account, and gamer may denote an avatar or a character manipulated by them according to the context, or a device used by them.

Hereinafter, in the present disclosure, ‘item’ may include an object, a product, content, etc., and may denote equipment worn on in-game characters such as weapons, armor, accessories, clothes, and crystals, boards boarded by the in-game characters, consumers such as foods or potions, any digital content such as experiences or buffs acquirable by the user in the game, or cyber targets; however, the present disclosure is not limited thereto.

Hereinafter, in the present disclosure, ‘illustrated guide’ may denote a system for accommodating, collecting, or storing in-game items.

Hereinafter, in the present disclosure, ‘illustrated guide pool’ may denote a storage space that is different from an inventory of a user, which is distinguished from the inventory of the user for accommodating, collecting, or storing in-game items. The illustrated guide pool is a storage space granted to each user in a game system. According to examples, the illustrated guide pool may be shared by characters or accounts of the user.

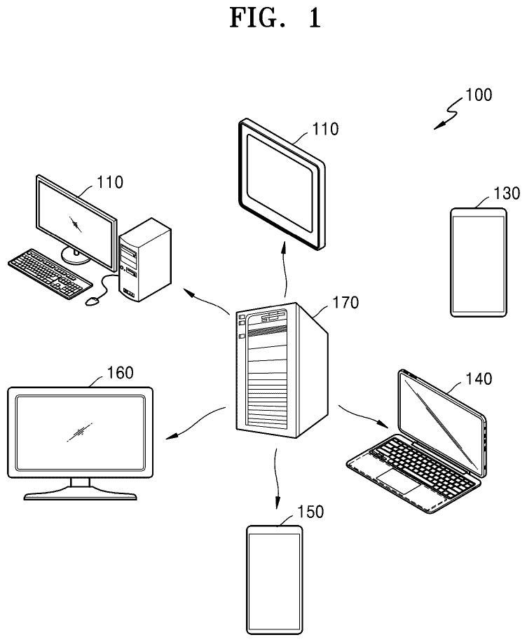

FIG. 1 is a diagram showing a game providing system 100 including a server and a user terminal, according to various embodiments of the present disclosure.

The game providing system 100 according to the present disclosure may include a server 170 and at least one user terminal 110 to 160. The server 170 may provide the at least one user terminal 110 to 160 with various online activities through a network. The server 170 may provide the at least one user terminal 110 to 160 with online activities at the same time.

According to an embodiment of the present disclosure, the server 170 may include a single server, an assembly of servers, a cloud server, etc., but is not limited thereto. The server 170 may provide the at least one user terminal 110 to 160 with various online activities, and may include a database for storing data for the online activities of the at least one user terminal 110 to 160. Also, the server 170 may include a payment server that generates and processes a payment event. As described above, the server 170 may be a game providing apparatus.

According to an embodiment of the disclosure, the network may denote a connection established (or formed) by using all communication methods and may denote a communication network connected through all communication methods for transmitting and receiving data between a terminal and a terminal or between a terminal and a server.

All the communication methods may include all communication methods such as communication through a certain communication standard, a certain frequency band, a certain protocol, or a certain channel. For example, the communication methods may include Bluetooth, Bluetooth Low Energy (BLE), Wi-Fi, Zigbee, Third Generation (3G), Long-Term Evolution (LTE), a communication method through ultrasound, or the like and may include short-range communication, long-range communication, wireless communication, and wired communication. However, the present disclosure is not limited thereto.

According to an embodiment of the present disclosure, the short-range communication method may mean a communication method in which communication is possible only when a device (a terminal or a server) performing communication is within a certain range, and may include, for example, Bluetooth, near-field communication (NFC), or the like. The long-range communication method may denote a communication method in which a device performing communication may communicate regardless of the distance. For example, the long-range communication method may denote a method in which two devices performing communication through a repeater such as an AP may communicate even when spaced apart from each other by a certain distance or more, and may include a cellular network (3G or LTE) such as Short Message Service (SMS) and telephone. However, the present disclosure is not limited thereto. The meaning of receiving on-line activities by using a network may include the meaning that communication between a game server and a terminal may be performed through all communication methods.

Throughout the specification, at least one user terminal 110 to 160 may include, but is not limited to, not only a personal computer 110, a tablet 120, a cellular phone 130, a laptop computer 140, a smartphone 150, or a TV 160, but also various electronic devices such as personal digital assistants (PDAs), portable multimedia players (PMPs), navigations, MP3 players, digital cameras, refrigerators, washing machines, and cleaners. As described above, the at least one user terminal 110 to 160 may denote a game providing apparatus.

According to an embodiment of the present disclosure, the online activities may include, but is not limited to, on-line games, portal services, and social network service (SNS). Also, the online game may include various genres such as sports, massive multiplayer online role-playing game (MMORPG), Aeon of Strife (AOS), first-person shooter (FPS), trading card game (TCG), collectible card game (CCG), or the like. In addition, the online game may be a game of competition between users, or may be a game of competition between a user and a computer (e.g., artificial intelligence). However, the present disclosure is not limited thereto and there is no limit to the type of the online game.

The game providing apparatus according to an embodiment of the present disclosure may transfer items from an inventory of a user to an illustrated guide pool and provide the user with rewards, based on a store request for storing the items held by the user in the illustrated guide pool. The game providing apparatus may transfer the items from the illustrated guide pool to the inventory of the user and retrieve the reward provided to the user, based on a return request for returning the items stored in the illustrated guide pool to the inventory of the user.

The game providing apparatus according to an embodiment of the present disclosure may transfer items from an inventory of a user to an illustrated guide pool and provide the user with rewards, based on a store request for storing the items held by the user in the illustrated guide pool. The game providing apparatus may display a character of the user wearing a preset item set, based on all of the items included in the preset item set being stored in the illustrated guide pool as the items are transferred to the illustrated guide pool.

The game providing apparatus according to an embodiment of the present disclosure may transfer a plurality of items from an inventory of a user to an illustrated guide pool and provide the user with rewards, based on a store request for storing the plurality of items held by the user in the illustrated guide pool.

The game providing system 100 according to an embodiment of the present disclosure may transfer items from an inventory of a user to an illustrated guide pool and provide the user with rewards, based on a store request for storing the items held by the user in the illustrated guide pool. The game providing system 100 may transfer the items from the illustrated guide pool to the inventory of the user and retrieve the reward provided to the user, based on a return request for returning the items stored in the illustrated guide pool to the inventory of the user.

The game providing system 100 according to an embodiment of the present disclosure may transfer items from an inventory of a user to an illustrated guide pool and provide the user with a reward, based on a store request for storing the items held by the user in the illustrated guide pool. The game providing system 100 may display a character of the user wearing a preset item set, based on all of the items included in the preset item set being stored in the illustrated guide pool as the items are transferred to the illustrated guide pool.

The game providing system 100 according to an embodiment of the present disclosure may collectively transfer a plurality of items from an inventory of a user to an illustrated guide pool and provide the user with rewards, based on a store request for storing the plurality of items held by the user in the illustrated guide pool.

According to an embodiment of the present disclosure, the server 170 may transfer items from an inventory of a user to an illustrated guide pool and provide the user with a reward, based on a store request for storing the items held by the user in the illustrated guide pool. The server 170 may transfer the items from the illustrated guide pool to the inventory of the user and retrieve the reward provided to the user, based on a return request for returning the items stored in the illustrated guide pool to the inventory of the user.

The server 170 according to an embodiment of the present disclosure may transfer items from an inventory of a user to an illustrated guide pool and provide the user with a reward, based on a store request for storing the items held by the user in the illustrated guide pool. The server 170 may send information for displaying a character of the user wearing a preset item set, based on all of the items included in the preset item set being stored in the illustrated guide pool as the items are transferred to the illustrated guide pool.

The server 170 according to an embodiment of the present disclosure may transfer a plurality of items from an inventory of a user to an illustrated guide pool and provide the user with a reward, based on a store request for storing the plurality of items held by the user in the illustrated guide pool.

According to an embodiment of the present disclosure, one of the at least one user terminal 110 to 160 may transfer an item from the inventory of the user to the illustrated guide pool, based on a store request for storing the item retained by the user in the illustrated guide pool. One of the at least one user terminal 110 to 160 may provide the user with a reward, as the item is transferred to the illustrated guide pool. One of the at least one user terminal 110 to 160 may transfer the item from the illustrated guide pool to the inventory of the user, based on a return request for returning the item stored in the illustrated guide pool to the inventory. One of the at least one user terminal 110 to 160 may retrieve the reward provided to the user, as the item is transferred to the inventory of the user.

In an embodiment, some or all the operations of the server 170 may be executed in the user terminal 110 to 160. For example, a method of providing the game service according to an embodiment of the present disclosure may be executed by the user terminal 110 to 160 without communicating with the server 170.

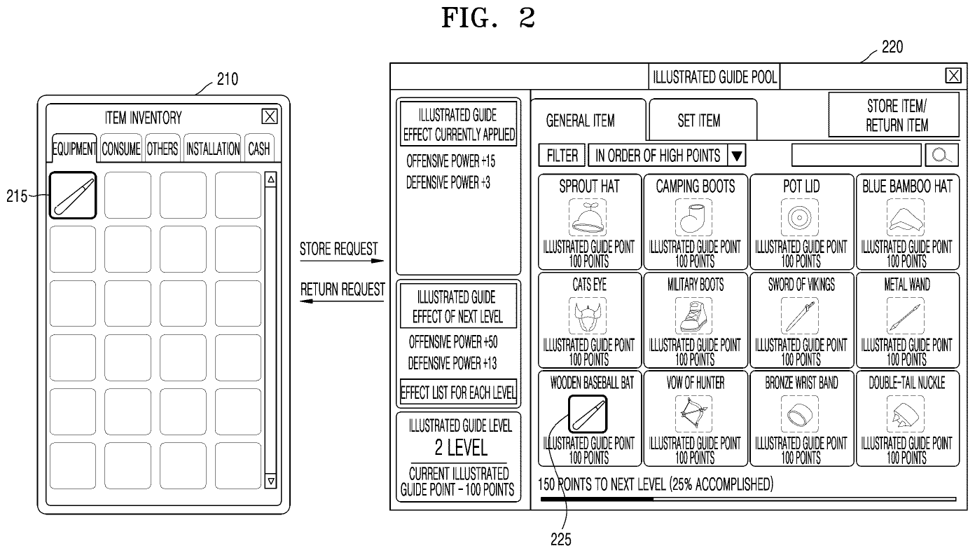

FIG. 2 is a conceptual diagram for describing an operation of transferring items, according to an embodiment of the present disclosure.

In the embodiment of the present disclosure, the game providing apparatus may transfer an item retained therein from an inventory 210 of a user to an illustrated guide pool 220, and may transfer an item retained in the illustrated guide pool 220 to the inventory 210. When transferring the item from the inventory 210 of the user to the illustrated guide pool 220, the game providing apparatus may provide the user with a reward. The game providing apparatus may retrieve the reward provided to the user when the item retained in the illustrated guide pool 220 is transferred to the inventory 210 of the user.

In an embodiment of the present disclosure, the game providing apparatus may transfer an item retained by the user from the inventory 210 of the user to the illustrated guide pool 220. For example, the game providing apparatus may identify the item retained by the user from the inventory 210 of the user. Also, the game providing apparatus may receive an input of a store request from the user, for storing the item retained by the user in the illustrated guide pool 220. For example, the game providing apparatus may identify a certain touch input from the user as a store request. The certain touch input is described as an example, but the present disclosure is not limited thereto. Also, the store request may be a kind of user input.

The user input in the present specification may include all actions, commands, or operations performed via a game interface by the user for interacting with the game system. The user input may be represented in various types, and may include at least one of a touch screen input, a keyboard input, a mouse clicking, a voice command, and a gesture.

For example, the game providing apparatus may transfer the item from the inventory 210 of the user to the illustrated guide pool 220, in response to the identification of the store request from the user.

In an embodiment, as the item from the inventory 210 of the user is transferred to the illustrated guide pool 220, the game providing apparatus may provide the user with a reward. The reward provided to the user may be provided in the type of game money, ability parameter, reward item, illustrated guide point, or variation in display with respect to item in the illustrated guide pool 220, and is not limited to the examples. For example, as the game providing apparatus transfers an equipment item from the inventory 210 of the user to the illustrated guide pool 220, the game providing apparatus may provide the user with 50,000 game money and the user may acquire 50,000 game money. For example, as the equipment item is transferred from the inventory 210 of the user to the illustrated guide pool 220, the game providing apparatus provides the user with 20% of experience points or improvement in the ability parameter by 3% (e.g., offensive power, defensive power, or damage, etc.) for improving the ability of character. For example, as the equipment item is transferred from the inventory 210 of the user to the illustrated guide pool 220, the game providing apparatus may provide the user with illustrated guide points. In an embodiment, the illustrated guide point may be a parameter that is calculated as a value according to storage of items in the illustrated guide system. In an embodiment, as the equipment item is transferred from the inventory 210 of the user to the illustrated guide pool 220, the game providing apparatus may provide the user with 30 HP recovery potions. For example, as the equipment item is transferred from the inventory 210 of the user to the illustrated guide pool 220, the game providing apparatus may provide the user with an interface in which display of the corresponding equipment item in the illustrated guide system is changed differently.

In an embodiment, the game providing apparatus may transfer an item stored in the illustrated guide pool 220 to the inventory 210 of the user. For example, the game providing apparatus may receive an input of a return request from the user, for returning the item stored in the illustrated guide pool 220 to the inventory 210. In response to the identification of the return request from the user, the game providing apparatus may transfer the item from the illustrated guide pool 220 to the inventory 210 of the user.

In an embodiment, as the stored item is transferred from the illustrated guide pool 220 to the inventory 210 of the user, the game providing apparatus may retrieve the reward provided to the user. When the item is transferred from the illustrated guide pool 220 to the inventory 210 of the user, the game providing apparatus may retrieve all or some of the reward provided to the user when the item is transferred from the inventory 210 to the illustrated guide pool 220. For example, when the item stored in the illustrated guide pool 220 is transferred from the illustrated guide pool 220 to the inventory 210 of the user, the game providing apparatus may subtract the provided value calculated in the illustrated guide system. When the item stored in the illustrated guide pool 220 is transferred from the illustrated guide pool 220 to the inventory 210 of the user, the game providing apparatus may subtract the 20% of experience points that have been acquired, or retrieve the 3% improvement in the ability parameter (e.g., offensive power, defensive power, damage, etc.).

In addition, even when the return request to transfer the equipment item from the illustrated guide pool 220 to the inventory 210 of the user, the game providing apparatus may not transfer the equipment item from the illustrated guide pool 220 to the inventory 210 when it is not possible to retrieve the provided reward.

In an embodiment, the game providing apparatus may identify that the user retains an equipment item 215 in the name of ‘wooden baseball bat’ in the inventory 210 of the user. The game providing apparatus may identify the store request to store the equipment item in the illustrated guide pool 220. Based on the store request, the game providing apparatus may transfer the equipment item 215 from the inventory 210 of the user to the illustrated guide pool 220. Also, as the equipment item 215 is transferred from the inventory 210 to the illustrated guide pool 220, the game providing apparatus may provide the user with illustrated guide points.

In an embodiment, the game providing apparatus may identify an equipment item 225 from among the items stored in the illustrated guide pool 220. The game providing apparatus may identify a return request for returning the equipment item from the illustrated guide pool 220 to the inventory 210. Based on the return request, the game providing apparatus may transfer the equipment item 225 from the illustrated guide pool 220 to the inventory 210 of the user. Also, as the equipment item 225 is transferred from the illustrated guide pool 220 to the inventory 210, the game providing apparatus may retrieve, from the user, the reward provided to the user.

Hereinafter, an interface of the illustrated guide pool 220 according to an embodiment of the present disclosure is described in detail below.

In an embodiment, the illustrated guide pool 220 may include illustrated guide information regarding at least one of kinds of items, items that are stored or may be stored in the illustrated guide, illustrated guide points that are acquired or may be acquired in correspondence with each item, current illustrated guide points, illustrated guide level, effects acquired through the illustrated guide system, and effects that may be acquired through the illustrated guide system.

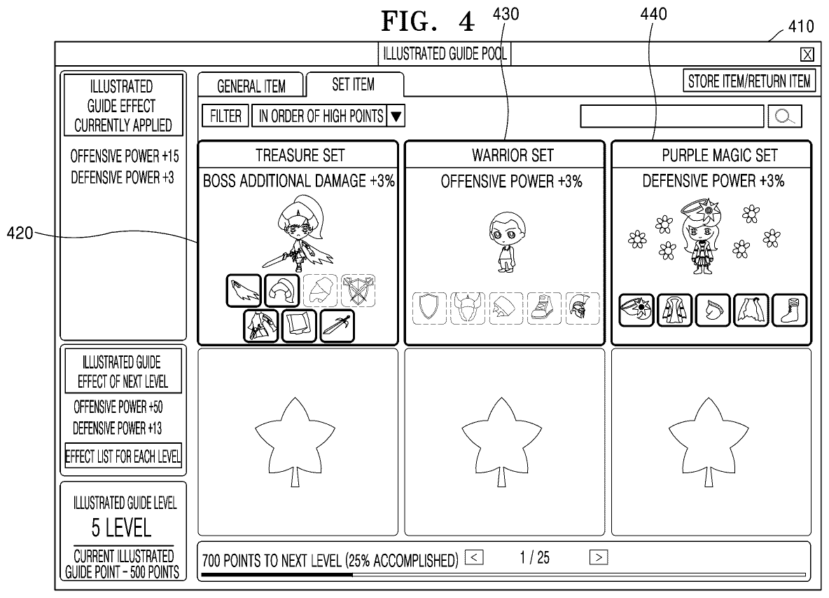

In an embodiment, the game providing apparatus may display the illustrated guide pool 220 with the items that are distinguished according to the kinds thereof. For example, when the items are classified as general items or set items, the game providing apparatus may only display general items or set items. In addition, the set items may be included in an item set that is set in the illustrated guide in advance, and the items that are not the set items, from among the items that may be stored in the illustrated guide, may be general items. According to the implemented examples, the general items and the set items may be implemented along with each other. The criterion for dividing the item is not limited to whether the item is a general item or a set item. The configuration associated with the set item will be described in detail with reference to FIG. 4.

In an embodiment, each item of the illustrated guide pool 220 may be classified and displayed using at least one of a form, a shape, and a color according to whether the corresponding item is an item stored in the illustrated guide. For example, when a first item in the illustrated guide pool 220 is expressed in a gray scale image, dashed lines are displayed around the first item, or a plus sign is identified as overlapping the first item, the first item may be identified as an item that is not stored in the illustrated guide. The item that is not stored may be a storable item. When a second item is expressed in a color image or twinkling special effect is applied around the second item, the second item may be identified as an item stored in the illustrated guide.

In an embodiment, the game providing apparatus may display the reward that has been acquired or may be acquired with respect to each item in the illustrated guide pool 220. For example, it may be displayed that 120 illustrated guide points may be acquired with the first item and 100 illustrated guide points have been acquired with the second item. The game providing apparatus may display that an effect of 3% improvement in the defensive power has been acquired with a third item or 3000 game money may be acquired with a fourth item.

In an embodiment, when the illustrated guide points are provided as a reward, the game providing apparatus may display the current illustrated guide points representing the illustrated guide points that have been acquired so far. When the illustrated guide level is determined according to the current illustrated guide points, the game providing apparatus may display the illustrated guide level as well. When there is an effect provided to the user according to the illustrated guide level, the game providing apparatus may display the effects that have been acquired so far according to the illustrated guide level. Also, when a next illustrated guide level is accomplished, the game providing apparatus may display the effect that may be acquired through the illustrated guide system. Also, the game providing apparatus may display the illustrated guide points that have to be acquired additionally in order to achieve next illustrated guide level and information associated with the illustrated guide points that have to be acquired additionally.

In an embodiment, the game providing apparatus may identify the store request or return request through the interface of the illustrated guide pool 220. For example, the game providing apparatus may identify a user input about the shape of an item that is not stored in the illustrated guide as a store request. The game providing apparatus may identify a user input about the shape of an item stored in the illustrated guide as a return request. Also, the game providing apparatus may acquire stored item information about at least one item that is to be stored in the illustrated guide pool 220 by the user through a user input, by using a tool in the illustrated guide tool 220. For example, the tool capable of acquiring the stored item information may be expressed as a banner ‘select store item’ or ‘store item’ in the illustrated guide pool 220, and the game providing apparatus may acquire the stored item information by using the tool capable of acquiring the stored item information in the illustrated guide pool 220.

In an embodiment, the user may store the item in the illustrated guide pool, and thus, may acquire a new usage of the item. Accordingly, the illustrated guide system may allow the user to have desire to collect items, and provides a reward for each of the collected or stored items, to thereby satisfy the achievement desire of the user and induce the in-game play of the user. Moreover, due to the user's desire to collect items, item transactions among users may active occur.

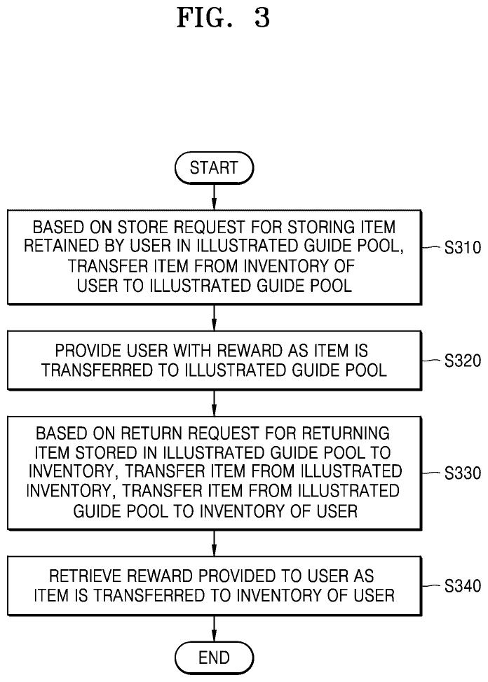

FIG. 3 is a flowchart for describing a method of providing a game service, according to an embodiment of the present disclosure.

In operation S310, the game providing apparatus may transfer items from an inventory of a user to an illustrated guide pool, based on a store request for storing the items retained by the user in the illustrated guide pool.

In an embodiment of the present disclosure, the game providing apparatus may transfer an item retained by the user from the inventory of the user to the illustrated guide pool. For example, the game providing apparatus may identify a store request from the user for storing items retained by the user in the illustrated guide pool. The game providing apparatus may transfer the item in the inventory to the illustrated guide pool based on the identification of the store request. In addition, for the convenience of description, the item in the inventory that is requested to be stored is expressed in a singular form, but may be plural. Therefore, the store request may be a request for storing at least one item retained by the user in the illustrated guide pool collectively.

In an embodiment, the game providing apparatus may identify the store request through an interface of the inventory of the user or an interface of the illustrated guide pool. The store request may be a kind of user input. The game providing apparatus may identify an input of dragging the item from the inventory interface to the illustrated guide pool interface as the store request. The game providing apparatus may identify the store request through an input associated with the item that is not stored in the illustrated guide pool interface. Also, the game providing apparatus may identify the store request by using a tool for selecting an item to be stored in the illustrated guide pool interface.

In operation S320, the game providing apparatus may provide the user with a reward as the item is transferred to the illustrated guide pool.

In an embodiment, the game providing apparatus may provide the user with a reward as the item in the inventory of the user is transferred to the illustrated guide pool. The reward may be at least one of the ability parameter, game money, reward item, illustrated guide points, and a change in display with respect to the items in the illustrated guide pool.

In an embodiment, the game providing apparatus may calculate the illustrated guide points based on at least one item stored in the illustrated guide pool. For example, the game providing apparatus may display the illustrated guide points determined by adding the points respectively corresponding to the items stored in the illustrated guide pool. The game providing apparatus may provide the user with the reward that varies depending on the illustrated guide points. For example, the game providing apparatus may provide the user with improvement in the ability parameter, which is in proportional to the illustrated guide points, as the reward. The game providing apparatus may determine the illustrated guide level according to the illustrated guide points, and may provide the reward that varies depending on the determined illustrated guide level. The illustrated guide levels according to sections of the illustrated guide points may be set in advance.

In an embodiment, the game providing apparatus may acquire information about the preset item set. The items included in the preset item set may be a plurality of items. When the plurality of set items included in the preset item set are all stored, the game providing apparatus may provide the user with additional reward. For example, a first set item and a second set item may be included in the preset item set.

In an embodiment, the game providing apparatus may provide the user with additional reward, based on that all of the items included in the preset item set are stored in the illustrated guide pool. For example, the game providing apparatus may provide the user with additional reward, based on the first set item and the second set item included in the preset item set being identified to be stored in the illustrated guide pool. The additional reward may be provided in the type of a change in display with respect to game money, ability parameter, reward item, illustrated guide point, or a change in display with respect to item in the illustrated guide pool 220. Also, the additional reward may be of the same kind as the reward provided to the user according to the transferring of the first set item or the second set item to the illustrated guide pool.

In an embodiment, at least one of the illustrated guide pool, reward, and additional reward may be shared by one or more characters included in user's account. For example, with respect to a first character and a second character included in one user's account, the game providing apparatus may provide the second character with all or some of the rewards acquired by the first character. For example, when the game providing apparatus provides the first character with 3% improvement in the ability parameter as a reward, the game providing apparatus may provide the second character with 1% improvement in the ability parameter as a reward.

In an embodiment, the game may be a block chain game. When the game of the present disclosure is the block chain game, an item transferred from the inventory of the user to the illustrated guide pool or from the illustrated guide pool to the inventory of the user may be a non-fungible token (NFT). When the item of the present disclosure is an NFT, transferring of an item from the inventory of the user to the illustrated guide pool may corresponding to staking of an item on a block chain network. The staking may be an action of depositing the NFT retained by the user on the block chain network and acquiring a reward with respect to the deposit. The store request may be a request for staking an item. The illustrated guide pool may correspond to a space referred to as a wallet, a contract wallet, or a staking wallet that is a space in the block chain network in which the NFT is staked and deposited. The reward may be provided as a reward for verification of the block chain after utilizing the NFT in the verification of the block chain, because the NFT is staked and the NFT retained by the user is deposited in the block chain network.

In addition, it is described that, as the item is transferred from the inventory to the illustrated guide pool, the user is provided with a reward for convenience of description, but the transferring of item and providing of the reward are generated based on the store request and may be performed simultaneously or within a certain period of time.

In operation S330, the game providing apparatus may transfer the item from the illustrated guide pool to the inventory of the user, based on the return request to return the item stored in the illustrated guide pool to the inventory.

In an embodiment, the game providing apparatus may transfer the item stored in the illustrated guide pool from the illustrated guide pool to the inventory. For example, the game providing apparatus may identify the return request to return the item stored in the illustrated guide pool to the inventory. The game providing apparatus may transfer the item in the illustrated guide pool to the inventory of the user, based on the identification of the return request. In addition, for convenience of description, the item in the illustrated guide pool, which is requested to be returned, is expressed in the singular form, but may be plural. Therefore, the return request may be a request for returning at least one item in the illustrated guide pool to the inventory of the user.

In an embodiment, the game providing apparatus may identify the return request through an interface of the inventory of the user or an interface of the illustrated guide pool. The return request may be a kind of user input. The game providing apparatus may identify an input of dragging the item from the illustrated guide pool interface to the inventory interface of the user as the return request. The game providing apparatus may identify the return request through an input associated with the item stored in the illustrated guide pool interface. Also, the game providing apparatus may identify the return request by using a tool for selecting an item to be returned in the illustrated guide pool interface. For example, the game providing apparatus may acquire information about the item to be returned through a banner read as ‘return item’ or ‘select return item’ in the illustrated guide pool interface.

In operation S340, as the item is transferred to the inventory of the user, the reward provided to the user may be retrieved.

In an embodiment, as the item is transferred from the illustrated guide pool to the inventory of the user, the game providing apparatus may retrieve the reward provided to the user. The reward retrieved by the game providing apparatus may be all or some of the reward provided to the user.

In an embodiment, the game providing apparatus may calculate the illustrated guide points based on at least one item stored in the illustrated guide pool. The game providing apparatus may subtract or retrieve the illustrated guide points that have been acquired when the item is stored in the illustrated guide pool. For example, when the game providing apparatus provides the user with an effect of improving the ability parameter, that is, 3% improvement in the offensive power, as the second item is stored in the illustrated guide pool, the game providing apparatus may invalidate the effect of improving the ability parameter, that is, 3% improvement in the offensive power, as the second item is transferred to the inventory of the user. When the game providing apparatus provides the user with 100 illustrated guide points as the first item is stored in the illustrated guide pool, the game providing apparatus may subtract or retrieve 100 illustrated guide points as the first item is transferred to the inventory of the user. Also, when the illustrated guide points exceed the illustrated guide point section of the current illustrated guide level due to the subtracted or retrieved illustrated guide points, the illustrated guide level may be downgraded.

In an embodiment, the game providing apparatus may identify the return request with respect to set items included in the preset item set. In response to the identified return request, the game providing apparatus may transfer the set items from the illustrated guide pool to the inventory of the user. As the game providing apparatus transfers the set items from the illustrated guide pool to the inventory of the user, the game providing apparatus may identify that all of the items included in the preset item set are not stored in the illustrated guide pool. For example, the game providing apparatus may identify the return request for the first set item, between the first set item and the second set item that are all of the items included in the preset item set. The game providing apparatus may transfer the first set item from the illustrated guide pool to the inventory of the user, according to the return request. Because the first set item is transferred to the inventory of the user from the illustrated guide pool and the illustrated guide pool does not store the first set item included in the preset item set, the game providing apparatus may identify that not all of the items included in the preset item set are stored in the illustrated guide pool.

In an embodiment, as the set item is transferred to the inventory, the game providing apparatus may retrieve at least one of the reward and additional reward provided to the user. For example, the game providing apparatus may retrieve the additional reward from the user who has acquired the reward by storing all of the items included in the present item set in the illustrated guide pool. In addition, when the reward and the additional reward provided to the user may not be retrieved, the game providing apparatus may not transfer the set items from the illustrated guide pool to the inventory even though the return request is identified.

In an embodiment, when the game is a block chain game and the item is an NFT, transferring the item from the illustrated guide pool to the inventory of the user may correspond to retrieving and unstaking of the item from the block chain network. The unstaking may denote an action of retrieving the NFT that the user has deposited on the block chain network to the wallet of the user. The user is not limited to a person. Therefore, the return request may be a request to unstake the item.

In addition, it is described that the reward is retrieved from the user as the item is transferred to the inventory for the convenience of description, but the transferring of the item and the retrieving of the reward may be performed simultaneously or within a certain period of time based on the return request.

FIG. 4 is a diagram for describing an item set according to an embodiment of the present disclosure.

In an embodiment, the game providing apparatus may acquire information about the item set that is set in advance. The preset item set may include a plurality of items. When the plurality of items in the preset item set are stored, the game providing apparatus may provide the user with an additional reward other than the reward that is given when each of the items is stored.

In an embodiment, the game providing apparatus may provide the user with different additional reward according to the preset item set. For example, when all of the items included in a first item set are identified to be stored in an illustrated guide pool 410, the game providing apparatus may provide the user with an effect of improving the ability parameter, e.g., 2% improvement in boss additional damage. For example, when all of the items included in a second item set are identified to be stored in an illustrated guide pool 410, the game providing apparatus may provide the user with an effect of improving the ability parameter, e.g., 3% improvement in the offensive power. For example, when all of the items included in a third item set are identified to be stored in an illustrated guide pool 410, the game providing apparatus may provide the user with an effect of improving the ability parameter, e.g., 3% improvement in the defensive power. For example, when all of the items included in a fourth item set are identified to be stored in an illustrated guide pool 410, the game providing apparatus may provide the user with 1000 illustrated guide points. For example, when all of the items included in a fifth item set are identified to be stored in an illustrated guide pool 410, the game providing apparatus may provide the user with 2300 illustrated guide points.

In an embodiment, based on that the items included in the preset item set are stored, the game providing apparatus may display a character of the user, which wears the preset item set. For example, based on that all or some of the items included in the preset item set are stored, the game providing apparatus may display the character of the user, which wears the stored items. For example, based on that all of the items included in the preset item set are stored, the game providing apparatus may display a character of the user, which wears the preset item set.

In an embodiment, when the game providing apparatus displays the character of the user, which wears the preset item set, an additional accessory may be displayed on the preset item set.

For example, based on that some of the items included in the first item set are stored, the game providing apparatus may display the character of the user, which wears some set items stored therein, as a first set image 420. Based on that the not all of the set items included in the second item set are stored, the game providing apparatus may display only the basic character of the user as a second set image 430. The basic character of the user may have the outer appearance with no set item. Based on that all of the set items included in the third item set are stored, the game providing apparatus may display an additional accessory in addition to all of the set items included in the third item set, as a third set image 440. In addition, the present disclosure is not limited to the above examples, and the game providing apparatus may display more additional accessories as the number of stored items from among the items included in the preset item set increases.

According to an embodiment of the present disclosure, various content in the illustrated guide system may be provided to the user. When the user performs and accomplishes content with high difficulty, the user may experience high fulfillment.

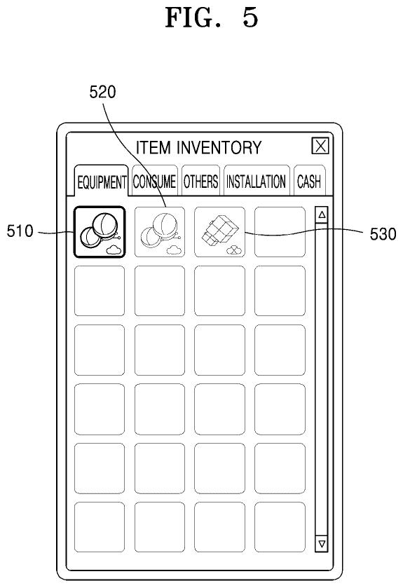

FIG. 5 is a diagram for describing an interface according to whether an item may be stored in an illustrated guide pool, according to an embodiment of the present disclosure.

In an embodiment, the game providing apparatus may identify at least one item in the inventory of the user. The game providing apparatus may classify the items that may be stored in the illustrated guide pool and the items that are impossible to be stored in the illustrated guide pool, from among the at least one item included in the inventory of the user. For example, the game providing apparatus may identify only the equipment item as the item that may be stored in the illustrated guide pool, and may identify the other items as the items that are impossible to be stored in the illustrated guide pool. From among the equipment items, weapons, protective gears, clothes, etc., may be only identified as the items that may be stored in the illustrated guide pool, and accessories may be identified as the item that are impossible to be stored in the illustrated guide pool. The items that may be stored in the illustrated guide pool and the items that are impossible to be stored in the illustrated guide pool are described with the example of the equipment items, but the present disclosure is not limited thereto. Information about at least one item in the inventory of the user may be referred to as inventory information.

In an embodiment, when the game of the present disclosure is a block chain game, the game providing apparatus may classify an item that is minted to an NFT as the item that may be stored in the illustrated guide pool and may classify an item that is not possible to be an NFT and has not been to be NFT as an item that may not be stored in the illustrated guide pool.

In an embodiment, the game providing apparatus may identify a first item 510, a second item 520, and a third item 530 included in the inventory of the user. The game providing apparatus may display a sign (e.g., blue cloud sign) indicating that the first item 510 is minted around the first item 510. The game providing apparatus may display a sign (e.g., gray cloud sign) indicating that the second item 520 may be minted but is not minted yet around the second item 520. The game providing apparatus may display a sign (e.g., cloud sign overlapping X sign) indicating that the third item 530 is an item that is impossible to be minted around the third item 530.

In an embodiment, the game providing apparatus may not store a plurality of items with the same name in the illustrated guide pool. Items with the same name that are already stored in the illustrated guide pool, the items that are impossible to be minted, and items that are not minted yet may be applied with an additional shading effect in order to indicate that the items may not be stored in the illustrated guide pool, when an inventory of the items is displayed.

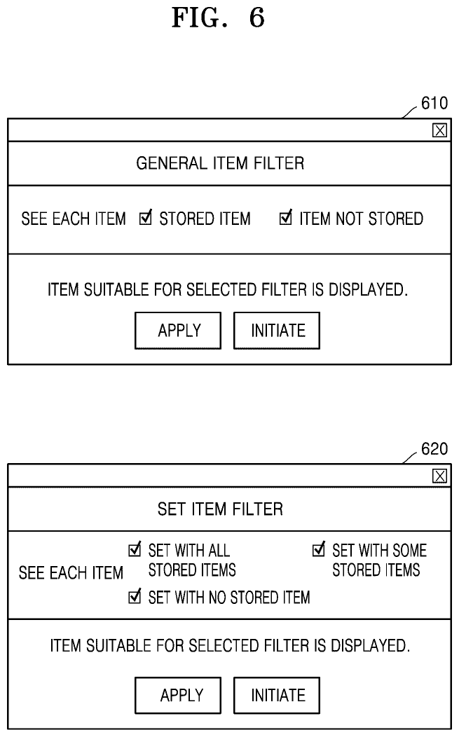

FIG. 6 is a diagram for describing an interface for filtering general items and set items in an illustrated guide pool, according to an embodiment of the present disclosure.

In an embodiment, the game providing apparatus may classify general items and set items through an illustrated guide pool interface.

In an embodiment, the game providing apparatus may classify and display the items that are stored and the items that are not stored through the illustrated guide pool interface, or may display all of the items that are stored and the items that are not stored.

In an embodiment, the game providing apparatus may identify items that are stored in the illustrated guide pool from items that are not stored in the illustrated guide pool, from among general items, by using a general item filter 610, through the illustrated guide pool interface. Based on a user input, the game providing apparatus may only display the items stored in the illustrated guide pool, or may only display the items that are not stored. Based on a user input requesting that all of the items stored in the illustrated guide pool and the items that are not stored in the illustrated guide pool are to be displayed, the game providing apparatus may display all of the general items including the items stored and not stored in the illustrated guide pool. Also, according to the user input, the game providing apparatus may align respective items based on a degree of reward and names, or may display all of the general items while priorly displaying the items that are stored.

In an embodiment, the game providing apparatus may identify the set items, of which all items are stored in the illustrated guide pool, some items are stored in the illustrated guide pool, and all items are not stored in the illustrated guide pool, by using a set item filter 620, through the illustrated guide pool interface. Based on the user input, the game providing apparatus may display at least one of a set of which items are all stored in the illustrated guide pool, a set of which some items are stored in the illustrated guide pool, and a set of which all items are not stored in the illustrated guide pool. Based on the user input, the game providing apparatus may align the items based on the degree of reward, names, and the number of stored items. Also, the game providing apparatus may display the set items along with the general items according to the user input.

In addition, the criteria of alignment and item classification are not limited to the above examples.

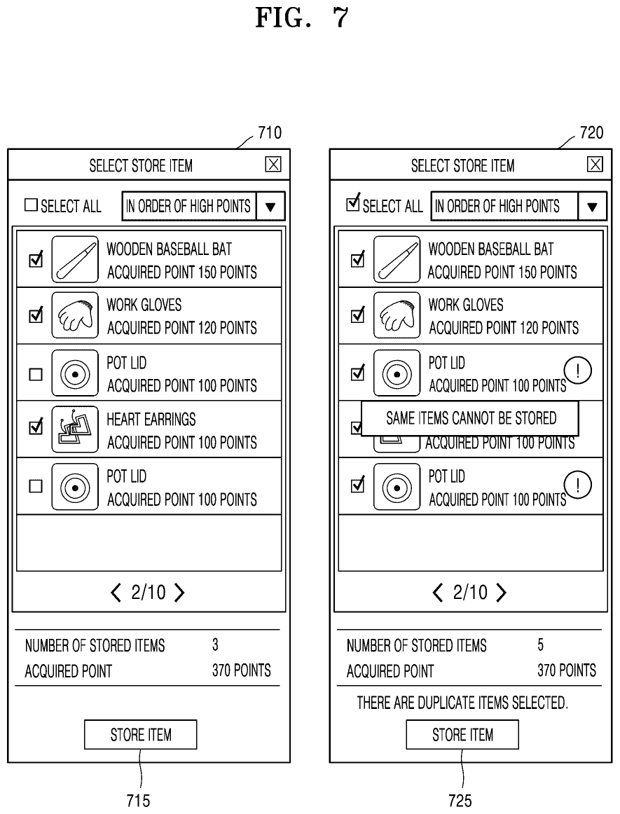

FIG. 7 is a diagram for describing an interface for transferring a plurality of items from an inventory of a user to an illustrated guide pool, according to an embodiment of the present disclosure.

In an embodiment, the game providing apparatus may transfer at least one item from the inventory of the user to the illustrated guide pool, based on a store request for storing at least one item retained by the user in the illustrated guide pool. For example, based on a store request for storing a plurality of items retained by the user in the illustrated guide pool, the game providing apparatus may collectively transfer the plurality of items from the inventory of the user to the illustrated guide pool.

In an embodiment, the game providing apparatus may identify at least one item that the user wants to store in the illustrated guide pool, through a user input with respect to the illustrated guide pool interface. Hereinafter, the processes in which the game providing apparatus identifies the items to be stored in the illustrated guide pool through a first store interface 710 and a second store interface 720 that are the store interfaces and stores the items in the illustrated guide pool are described below.

In an embodiment, the first store interface 710 may include store item information including storable items (hereinafter, store items), selection on each item, the number of selected store items according to the user input, and illustrated guide points that may be acquired according to the selected store items. For example, the game providing apparatus may identify the user input for selecting a first item, a second item, and a fourth item to be stored. Also, the first store interface 710 may include store item information indicating that the number of store items selected according to the user input is 3 and the illustrated guide point that may be acquired according to the selected store items is 370 points. Also, the game providing apparatus may identify the store request for storing the first item, the second item, and the fourth item in the illustrated guide pool through a first store request banner 715 in the first store interface 710. The game providing apparatus may transfer the item from the inventory of the user to the illustrated guide pool, based on the identified store request.

In an embodiment, the second store interface 720 may include, like the first store interface 710, store item information including storable items, selection on each item, the number of selected store items according to the user input, and illustrated guide points that may be acquired according to the selected store items. Additionally, the second store interface 720 may include a notification indicating the storing of the item is not possible, according to implementation examples. The game providing apparatus may identify a user input for selecting a plurality of items, in which at least one of names, outer appearances, and effects obtained while wearing is the same as the others, as the items to be stored in the illustrated guide pool. In this case, the game providing apparatus may provide the user with a notification indicating the items are impossible to be stored. For example, the game providing apparatus may acquire a user input for storing a third item and a fifth item, of which the names are the same, that is, ‘pot lid’, in the illustrated guide pool. When receiving the user input for storing the third item and the fifth item in the illustrated guide pool, the game providing apparatus may provide the user at least one of a caution sign for the third item and the fifth item, a notification indicating that the storing of the items is not possible, and a guide indicating that there are overlapping items. Also, the game providing apparatus may inactivate a second store request banner 725 that is an element for receiving a store request for storing the items in the illustrated guide pool.

In addition, storing of only one of the items with the same name is an example, and the present disclosure is not limited thereto.

In an embodiment, the user may simply play the game without any inconvenience of repeatedly performing unnecessary operations, through the interface associated with the illustrated guide pool.

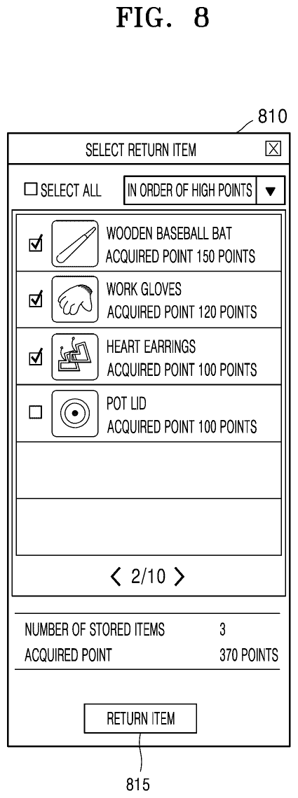

FIG. 8 is a diagram for describing an interface for transferring a plurality of items from an illustrated guide pool to an inventory of a user, according to an embodiment of the present disclosure.

In an embodiment, based on a return request for returning at least one item stored in the illustrated guide pool into the inventory, the game providing apparatus may transfer the at least one item stored in the illustrated guide pool from the illustrated guide pool to the inventory of the user collectively. For example, based on a return request for returning a plurality of items stored in the illustrated guide pool into the inventory, the game providing apparatus may transfer collectively the plurality of items stored in the illustrated guide pool from the illustrated guide pool to the inventory of the user.

In an embodiment, the game providing apparatus may identify at least one item that the user wants to return from the illustrated guide pool to the inventory of the user, through a user input with respect to the illustrated guide pool interface. Hereinafter, processes in which the game providing apparatus identifies the item that is to be returned from the illustrated guide pool to the inventory of the user through the return interface and returns the item from the illustrated guide pool to the inventory of the user are described below.

In an embodiment, a return interface 810 may include return item information including items that may be returned (hereinafter, return items), selection on each item, the number of return items selected according to a user input, and illustrated guide point that may be subtracted according to the selected return items. For example, the game providing apparatus may identify the user input for selecting a first item, a second item, and a third item. Also, the return interface 810 may include return item information indicating that the number of return items selected according to the user input is 3 and the illustrated guide point that may be subtracted according to the selected return items is 370 points. Also, the game providing apparatus may identify the return request for returning the first item, the second item, and the third item from the illustrated guide to the inventory of the user through a return request banner 815 in the return interface 810. Based on the identified return request, the game providing apparatus may return the items from the illustrated guide pool to the inventory of the user.

In an embodiment, the user may simply play the game without any inconvenience of repeatedly performing unnecessary operations, through the interface associated with the illustrated guide pool.

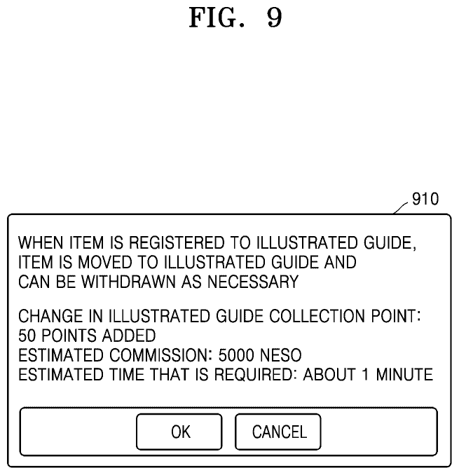

FIG. 9 is a diagram for describing an interface for responding a store request for storing items from an inventory of a user to an illustrated guide pool, according to an embodiment of the present disclosure.

In an embodiment, the game providing apparatus may identify a store request from the user for storing items retained by the user in the illustrated guide pool. When identifying the store request, the game providing apparatus may display store information about at least one of items to be stored, provided reward, commission generated when storing items in the illustrated guide pool, and a time taken to store the items in the illustrated guide pool.

For example, the game providing apparatus may provide the user with a store confirm interface 910. The store confirm interface 910 provided by the game providing apparatus may be provided in response to the identification of the store request. The store confirm interface 910 may include the store information indicating that the illustrated guide point that may be acquired when storing the item is 50 points, the commission for storing the item in the illustrated guide pool is 5000 NESO, and an estimated time is about 1 minute. Also, the store confirm interface 910 may include a notification indicating that the stored item may be returned when receiving a return request.

In an embodiment, the game providing apparatus may determine whether the item is stored in the illustrated guide pool by receiving the user input onto the store confirm interface 910. For example, when the game providing apparatus receives the user input for confirming the storage onto the store confirm interface 810, the game providing apparatus may transfer the corresponding item from the inventory of the user to the illustrated guide pool. When receiving the user input that does not confirm the storage onto the store confirm interface 910, the game providing apparatus may provide the user with a screen displayed before displaying the store confirm interface 910.

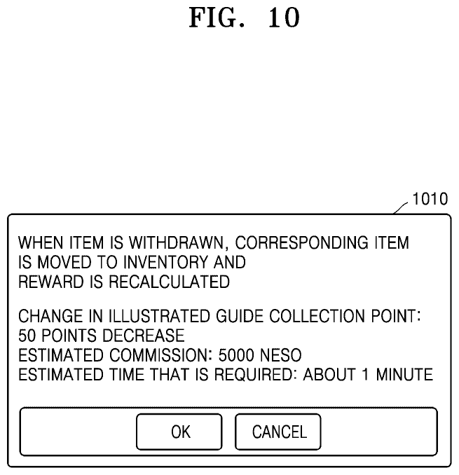

FIG. 10 is a diagram for describing an interface for responding a return request to return items from an illustrated guide pool to an inventory of a user, according to an embodiment of the present disclosure.

In an embodiment, the game providing apparatus may identify the return request to return the item stored in the illustrated guide pool to the inventory of the user. When identifying a return request, the game providing apparatus may display return information about at least one of the items to be returned, reward that is to be retrieved, commission generated when returning the item to the user interface, and a required time taken to return the item to the user interface.

For example, the game providing apparatus may provide the user with a return confirm interface 1010. The return confirm interface 1010 provided by the game providing apparatus may be provided in response to the identification of the return request. The return confirm interface 1010 may include return information indicating that the illustrated guide point that may be subtracted or retrieved according to the return of the item is 50 points, commission generated when returning the item to the inventory of the user is 5000 NESO, and an estimated time is about 1 minute. Also, the return confirm interface 1010 may notify the user of the changes that may occur when the illustrated guide points are subtracted or retrieved. For example, the return information may indicate that the illustrated guide level may be downgraded when the illustrated guide points are subtracted or retrieved.

In an embodiment, the game providing apparatus may determine whether the item is returned to the inventory of the user by receiving a user input onto the return confirm interface 1010. For example, when receiving the user input for confirming the return through the return confirm interface 1010, the game providing apparatus may transfer the corresponding item from the illustrated guide pool to the inventory of the user. When receiving the user input that does not confirm the return through the return confirm interface 1010, the game providing apparatus may provide the user with a screen displayed before displaying the return confirm interface 1010.

In an embodiment, through the interface associated with the illustrated guide pool according to the present disclosure, the user may reconsider whether the transferring of the item from the inventory to the illustrated guide pool is appropriate in consideration of circumstances of the user.

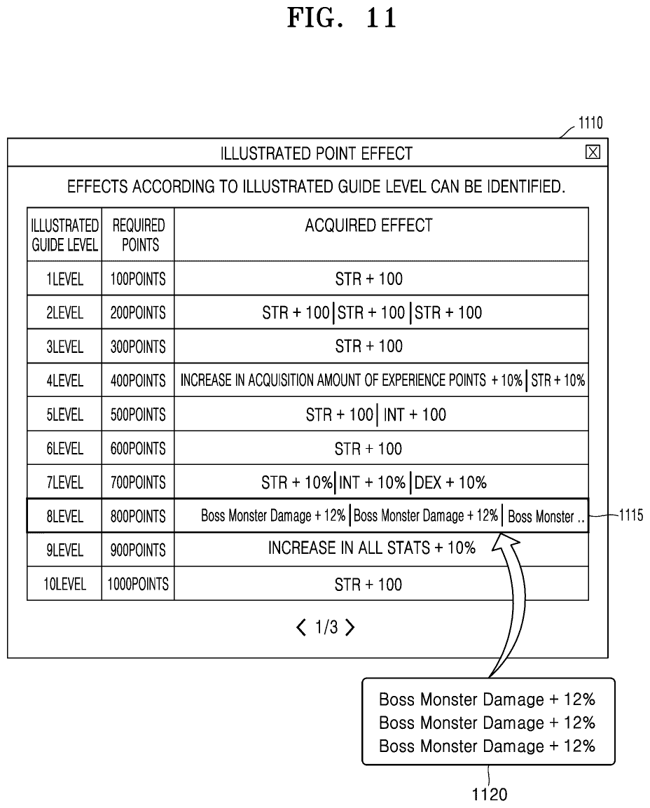

FIG. 11 is a diagram for describing an interface for displaying rewards according to a level of an illustrated guide, according to an embodiment of the present disclosure.

In an embodiment, the game providing apparatus may provide the user with information associated with the illustrated guide level. For example, the game providing apparatus may display information associated with the illustrated guide level by using a tool in the illustrated guide pool interface. Referring to FIG. 11, the game providing apparatus may provide the user with an illustrated guide level interface 1110, based on the identification of a user input with respect to a banner of ‘effect list for each level’.

In an embodiment, the game providing apparatus may provide the user with the information associated with the illustrated guide level in an ascending order of the illustrated guide level. For example, the illustrated guide level interface 1110 may provide the user with information about at least one of the illustrated guide level, points required to achieve the illustrated guide level, effects obtained when achieving the illustrated guide level, and illustrated guide points required to achieve each illustrated guide level. For example, the illustrated guide level interface 1110 may include information indicating that 400 points are necessary for achieving level 4, and when level 4 is accomplished, 10% improvement in an acquisition amount of experience points and 10% improvement in strength (STR) in the ability parameter are provided as rewards.

In an embodiment, when effects according to each level included in the illustrated guide level interface 1110 is described in a phrase of a length exceeding a preset region, the phrase exceeding a certain length may be omitted. In this case, the game providing apparatus receives a user input with respect to a certain region in each level in the illustrated guide level interface 1110, and then, may provide an illustrated guide effect interface 1120 overlapping or separating from the illustrated guide level interface 1110. For example, the game providing apparatus may provide the illustrated guide effect interface 1120 by identifying a touch input, a mouse clicking, or a mouse hovering on a level 8 region 1115.

In addition, the interface for displaying the reward according to the illustrated guide level is not limited to the above examples.

In an embodiment, through the interface associated with the illustrated guide pool according to the present disclosure, the user may reconsider whether the transferring of the item from the illustrated guide pool to the inventory of the user is appropriate in consideration of circumstances of the user.

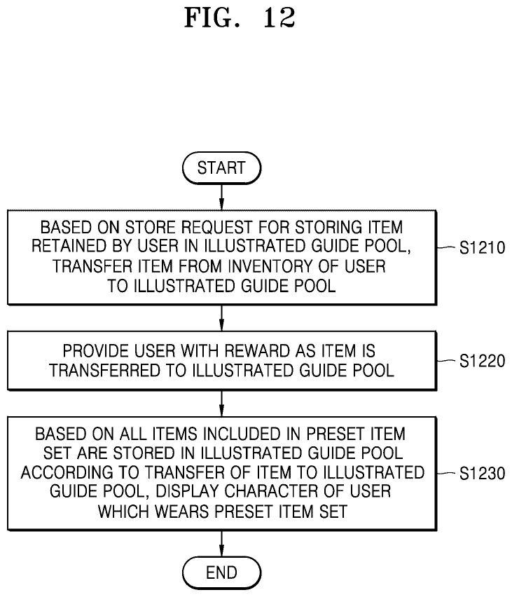

FIG. 12 is a flowchart for describing a method of providing game service, according to an embodiment of the present disclosure.

In operation S1210, the game providing apparatus may transfer items from an inventory of a user to an illustrated guide pool, based on a store request for storing the items retained by the user in the illustrated guide pool. Because operation S1210 corresponds to operation S310 of FIG. 3, detailed descriptions thereof are omitted.

In operation S1220, the game providing apparatus may provide the user with reward as the item is transferred to the illustrated guide pool. Because operation S1220 corresponds to operation S320 of FIG. 3, detailed descriptions thereof are omitted.

In operation S1230, the game providing apparatus may display a character of the user wearing a preset item set, based on all of the items included in the preset item set being stored in the illustrated guide pool as the item is transferred to the illustrated guide pool.

In an embodiment, referring to FIG. 4, the game providing apparatus may obtain information about a preset item set, and the preset item set may include a plurality of items. Based on that all of the items included in the preset item set are stored in the illustrated guide pool, the game providing apparatus may display a character of the user, which wears the preset item set. In addition, when the game providing apparatus displays the character of the user, which wears the preset item set, an additional accessory may be displayed on the preset item set. For example, the game providing apparatus may display an interface including the third set image 440 of FIG. 4. Operation S1230 is described in detail above with reference to FIG. 4, and redundant descriptions are omitted.

In an embodiment, through the illustrated guide pool interface of the present disclosure, the user's desire to achieve visually attractive character or aesthetic content that may reveal the use's individuality may be aroused.

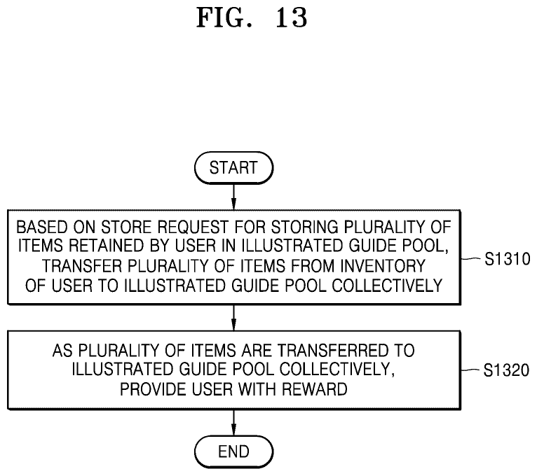

FIG. 13 is a flowchart for describing a method of providing a game service, according to an embodiment of the present disclosure.

In operation S1310, the game providing apparatus may collectively transfer items from an inventory of a user to an illustrated guide pool, based on a store request for storing a plurality of items retained by the user in the illustrated guide pool. Because operation S1310 corresponds to operation S310 of FIG. 3, detailed descriptions thereof are omitted.

In an embodiment, the game providing apparatus may transfer a plurality of items collectively from an inventory of a user to an illustrated guide pool, based on a store request for storing the plurality of items held by the user in the illustrated guide pool through the inventory interface or the illustrated guide pool interface.

In an embodiment, referring to FIG. 7, the game providing apparatus may obtain information about a plurality of items to be stored in the illustrated guide pool from the user, via the user input. Also, when obtaining or identifying a confirming user input to store the plurality of items in the illustrated guide pool, the game providing apparatus may transfer the items from the inventory of the user to the illustrated guide pool. Operation S1310 is described in detail above with reference to FIG. 7 or previously, and redundant descriptions are omitted.

In operation S1320, the game providing apparatus may provide the user with reward as the plurality of items are collectively transferred to the illustrated guide pool. Because operation S1320 corresponds to operation S320 of FIG. 3, detailed descriptions thereof are omitted.

In an embodiment, as the plurality of items are transferred from the inventory of the user to the illustrated guide pool, the game providing apparatus may provide the user with reward. The reward provided to the user may be sum of the rewards provided with respect to each of the items included in the plurality of items. For example, the reward provided to the user according to the storage of the first item included in the plurality of items may be an effect of improving the ability parameter, e.g., 3% improvement in the offensive power, and the reward according to the storage of the second item included in the plurality of items may be an effect of improving the ability parameter, e.g., 3% improvement in the defensive power. As the first item and the second item are transferred collectively from the inventory of the user to the illustrated guide pool, the game providing apparatus may provide the user with the effects of improving the ability parameters, including 3% improvement in the offensive power and 3% improvement in the defensive power, simultaneously or with a certain time interval.

In an embodiment, the user may simply play the game without any inconvenience of repeatedly performing unnecessary operations, through the illustrated guide pool interface.

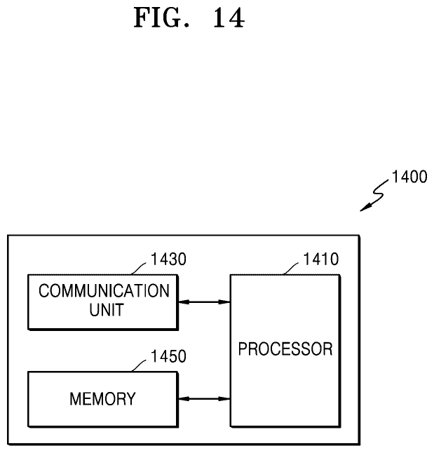

FIG. 14 is a diagram for describing detailed configuration of an apparatus for providing game, according to an embodiment of the present disclosure.

As shown in FIG. 14, a game providing apparatus 1400 according to some embodiments may include at least one processor 1410, a communication unit 1430, and a memory 1450. However, not all of the elements shown in FIG. 14 are the essential elements of the game providing apparatus 1400. The game providing apparatus 1400 may be embodied with more elements than the shown elements of FIG. 14 or may be embodied with fewer elements than the shown elements of FIG. 14. The game providing apparatus 1400 may be a user terminal, a server, a game network system or an additional device.

In an embodiment, the processor 1410 controls overall operations of the game providing apparatus 1400. For example, when the processor 1410 executes programs stored in the memory 1450 to control the communication unit 1430, the memory 1450, etc. The processor 1410 may control the operations of the game providing apparatus 1400 in the present specification by controlling the communication unit 1430, the memory 1450, etc. The programs stored in the memory may be instructions about the operations of the game providing apparatus.

In an embodiment, based the store request for storing the items retained by the user in the illustrated guide pool, as the items are transferred to the illustrated guide pool, the processor 1410 provides the user with a reward, and based on the return request for returning the items stored in the illustrated guide pool to the inventory, the items are transferred to the inventory of the user from the illustrated guide pool, and then the processor 1410 may retrieve the reward provided to the user as the items are transferred to the inventory of the user.

In an embodiment, as a first input from the user is identified, the processor 1410 may perform reinforcing of the equipment item independently from whether the user retains the equipment item, and based on the successful execution of the reinforcing of the equipment item, the processor 1410 may generate a first auxiliary item.

In an embodiment, the processor 1410 identifies a second input for reinforcing the first auxiliary item in correspondence with the additional reinforcing of the equipment item, and may generate a second auxiliary item for reinforcing the equipment item by reflecting a result of performing the reinforcing on the first auxiliary item based on reinforcing information and the second input.

In an embodiment, the processor 1410 may provide the user with additional reward, based on that all of the items included in the preset item set are stored in the illustrated guide pool.

In an embodiment, the processor 1410 may display the character of the user, which wears the preset item set, based on that all of the items included in the preset item set are stored in the illustrated guide pool.

Based on at least one item stored in the illustrated guide pool according to the present disclosure, the illustrated guide points may be displayed, and the reward varying depending on the illustrated guide points may be provided.

In an embodiment, the communication unit 1430 may perform communication with an external device under the control from the processor 1410. For example, the communication unit 1430 may perform the communication with an external device such as a payment server or a verification server according to the control from the processor 1410. Also, the communication unit 1430 may obtain user information or user input through the communication with an external interface.

In an embodiment, the memory 1450 may store programs for processing and controlling the processor 1410, and may store data input into/output from the game providing apparatus 1400. According to an embodiment of the present disclosure, the memory 1450 may store inventory information, illustrated guide information, information associated with the illustrated guide points, stored item information, returned item information, information about a preset item set, storage information, return information, information associated with an illustrated guide level, information associated with illustrated guide effects, etc.

In an embodiment, the processor 1410 may execute the method of providing game service, by using the programs stored in the memory 1450. For example, the processor 1410 may transfer an item form the inventory of the user to the illustrated guide pool based on at least one piece of information stored in the memory 1450 and a store request for storing the item retained by the user in the illustrated guide pool. The processor 1410 may provide the user with a reward as the item is transferred to the illustrated guide pool based on the illustrated guide information or information associated with the illustrated guide points stored in the memory 1450. The processor 1410 may transfer the item from the illustrated guide pool to the inventory of the user, based on the at least one piece of information stored in the memory 1450 and a return request for returning the item stored in the illustrated guide pool to the inventory. The processor 1410 may retrieve the reward provided to the user as the item is transferred to the inventory of the user, by using at least one piece of information stored in the memory 1450.

The memory 1450 according to the embodiment may include a storage medium of at least one type of a flash memory type, a hard disk type, a multimedia card micro type, a card type memory (e.g., an SD or XD memory, etc.), random access memory (RAM), a static RAM (SRAM), a read-only memory (ROM), an electrically erasable programmable ROM (EEPROM), a programmable (PROM), a magnetic memory, a magnetic disk, and an optical disk. Also, in an embodiment, the programs stored in the memory 1450 may be classified as a plurality of modules according to functions thereof.

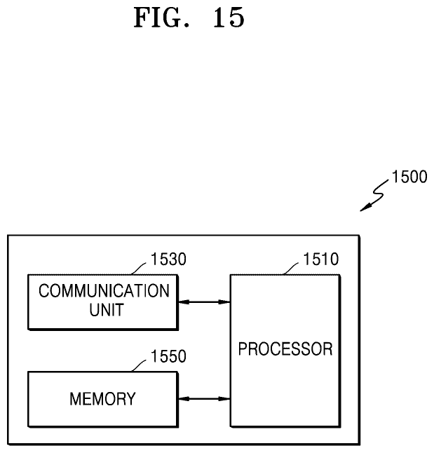

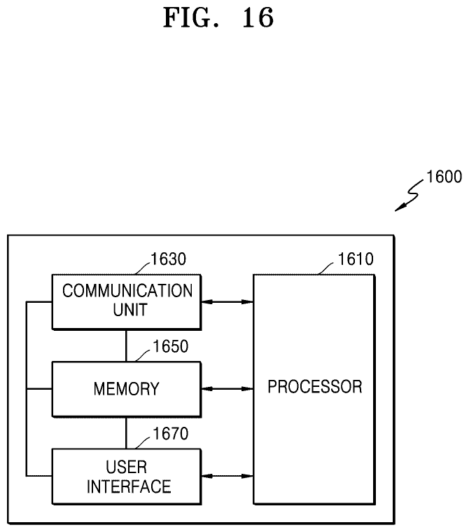

In an embodiment, the method of providing game service may be executed in the game providing apparatus 1400, a server, or a user terminal, and at least one element included in the game providing apparatus 1400 may implement the embodiments described above with reference to FIGS. 1 to 13. In addition, the method of providing game service may be performed by the server and the user terminal individually or along with each other. Configurations of the server and the user terminal are described in detail below with reference to FIGS. 15 and 16.

As shown in FIG. 15, a server 1500 according to some embodiments may include at least one processor 1510, a communication unit 1530, and a memory 1550. However, not all of the elements shown in FIG. 15 are the essential elements of the server 1500. The server 1500 may be embodied by more elements than the elements shown in FIG. 15 or less embodiments than the elements shown in FIG. 15.

In an embodiment, the processor 1510 controls overall operations of the server 1500. For example, when the processor 1510 executes programs stored in the memory 1550 to control the communication unit 1530, the memory 1550, etc. The processor 1510 may control the operations of the server 1500 in the present specification by controlling the communication unit 1530, the memory 1550, etc.

In an embodiment, based the store request for storing the items retained by the user in the illustrated guide pool, as the items are transferred to the illustrated guide pool, the processor 1510 provides the user with a reward, and based on the return request for returning the items stored in the illustrated guide pool to the inventory, the items are transferred to the inventory of the user from the illustrated guide pool, and then the processor 1510 may retrieve the reward provided to the user as the items are transferred to the inventory of the user.

In an embodiment, operations of the processor 1510 may correspond to those of the processor 1410 in the game providing apparatus 1400 described above with reference to FIG. 14, and detailed descriptions thereof are omitted.

The communication unit 1530 may provide a query to the user terminal 1600 and receive response information to the query, under control by the processor 1510. In addition, according to an embodiment, the communication unit 1530 may transmit and receive data to and from the user terminal 1600, and the data transmitted and received to and from the user terminal 1600 may include control data for controlling the user terminal 1600 or a program included in the user terminal 1600.

The memory 1550 may store a program for the processor 1510 to perform processing and control, and may store data input to or output from the server 1500. According to an embodiment, the memory 1550 may store information that the memory 1450 of the game providing apparatus 1400 shown in FIG. 14 may store.

In an embodiment, the processor 1510 may execute the method of providing game service, by using the programs stored in the memory 1550.

The memory 1550 according to the embodiment may include a storage medium of at least one type of a flash memory type, a hard disk type, a multimedia card micro type, a card type memory (e.g., an SD or XD memory, etc.), random access memory (RAM), a static RAM (SRAM), a read-only memory (ROM), an electrically erasable programmable ROM (EEPROM), a programmable (PROM), a magnetic memory, a magnetic disk, and an optical disk. Also, in an embodiment, the programs stored in the memory 1550 may be classified as a plurality of modules according to functions thereof.

In addition, according to an embodiment, the method of providing game service may be performed by the server 1500 and the user terminal 1600 in a distributed manner, may be individually performed by the server 1500 and the user terminal 1600, or may be performed by the game providing apparatus 1400.

FIG. 16 is a diagram for describing a detailed configuration of a user terminal according to various embodiments of the present disclosure.

As illustrated in FIG. 16, the user terminal 1600 according to some embodiments may include at least one processor 1610, a communication unit 1630, a memory 1650, and a user interface 1670. However, not all of the elements shown in FIG. 16 are the essential elements of the user terminal 1600. The user terminal 1600 may be implemented by more or fewer components than the components illustrated in FIG. 16.

In an embodiment, the processor 1610 controls overall operations of the user terminal 1600. For example, when the processor 1610 executes programs stored in the memory 1650 to control the communication unit 1630, the memory 1650, the user interface 1670, etc. The processor 1610 may control the operation of the user terminal 1600 in the specification by controlling the communication unit 1630, the memory 1650, and the user interface 1670.

In an embodiment, based the store request for storing the items retained by the user in the illustrated guide pool, as the items are transferred to the illustrated guide pool, the processor 1610 provides the user with a reward, and based on the return request for returning the items stored in the illustrated guide pool to the inventory, the items are transferred to the inventory of the user from the illustrated guide pool, and then the processor 1610 may retrieve the reward provided to the user as the items are transferred to the inventory of the user.

In an embodiment, operations of the processor 1610 may correspond to those of the processor 1410 in the game providing apparatus 1400 described above with reference to FIG. 14, and detailed descriptions thereof are omitted.

The communication unit 1630 may provide a query to the server 1500 and receive response information to the query, under control by the processor 1610. In addition, according to an embodiment, the communication unit 1630 may transmit and receive data to and from the server 1500, and the data transmitted and received to and from the server 1500 may include control data for controlling the user terminal 1600 or a program included in the user terminal 1600.

According to an embodiment, the communication unit 1630 may include a Bluetooth communication unit, a BLE communication unit, an NFC unit, a wireless local area network (WLAN) (e.g., Wi-Fi) communication unit, a Zigbee communication unit, an Infrared Data Association (IrDA) communication unit, a Wi-Fi Direct (WFD) communication unit, an ultra-wideband (UWB) communication unit, an Ant+ communication unit, etc., but is not limited thereto.

In addition, according to an embodiment, the communication unit 1630 transmits and receives radio signals to and from at least one of a base station, an external terminal, and a server, over a mobile communication network. Here, the wireless signal may include a voice call signal, a video call signal, or various types of data according to transmission/reception of texts/multimedia messages.

The memory 1650 may store a program for the processor 1610 to perform processing and control, and may store data input to or output from the user terminal 1600. According to an embodiment, the memory 1650 may store information about a game. For example, the memory 1650 may store at least one piece of information that the memory 1450 of the game providing apparatus in FIG. 14 may store.

In an embodiment, the processor 1610 may execute the method of providing game service, by using the programs stored in the memory 1650.

The memory 1650 according to the embodiment may include a storage medium of at least one type of a flash memory type, a hard disk type, a multimedia card micro type, a card type memory (e.g., an SD or XD memory, etc.), random access memory (RAM), a static RAM (SRAM), a read-only memory (ROM), an electrically erasable programmable ROM (EEPROM), a programmable (PROM), a magnetic memory, a magnetic disk, and an optical disk. Also, in an embodiment, the programs stored in the memory 1650 may be classified as a plurality of modules according to functions thereof.

According to an embodiment, the user interface 1670 may include various interfaces. For example, the user interface 1670 may include various interfaces, such as a key pad, a dome switch, a voice input interface, a fingerprint input interface, a touch input interface (e.g., a touch-type capacitive touch pad, a pressure-type resistive overlay touch pad, an infrared sensor-type touch pad, a surface acoustic wave conduction touch pad, an integration-type tension measurement touch pad, a piezoelectric effect-type touch pad, etc.), a camera, a jog wheel, or a jog switch, and may link various sensors, such as an acceleration sensor, a position sensor, a temperature sensor, or an optical sensor, to a user interface. The disclosure is not limited to the above examples.

In addition, according to an embodiment, the user interface 1670 may further include an output unit (not shown). The output unit may include at least one of a liquid-crystal display, a thin-film-transistor liquid-crystal display, an organic light-emitting diode, a flexible display, a three-dimensional (3D) display, and an electrophoretic display. In a case in which a display and a touch pad constitute a layer structure to form a touch screen, the display may serve as an input device in addition to an output device. When the display and a touch pad are configured as a touch screen in a layered structure, the display may be used as an input device, in addition to as an output device. In addition, the output unit (not shown) may include a light-emitting diode (LED) lamp, a vibration motor, a speaker, a flash, and the like, but is not limited to the above examples.

In addition, according to an embodiment, the user interface 1670 may output a notification of game information in the form of an image, a video, a sound, a vibration, a lamp, or the like.

In an embodiment, the user interface 1670 may include an interface of the inventory 210 of the user and the interface of the illustrated guide pool 220 shown in FIG. 2, the inventory interface and the illustrated guide pool interface shown in FIG. 3, the illustrated guide pool interface shown in FIG. 6, the store interface, the first store interface 710, and the second store interface 720 of FIG. 7, the return interface 810 of FIG. 8, the store confirm interface 910 of FIG. 9, the return confirm interface 1010 of FIG. 10, and the illustrated guide level interface 1110 and the illustrated guide effect interface 1120 of FIG. 11. However, the above interfaces are described as examples of the user interface 1670, and the user interface 1670 of the disclosure may further include various interfaces.

The apparatus described herein may be implemented using hardware components, software components, and/or combination of the hardware components and the software components. For example, the apparatuses and the components described in the embodiments may be implemented using, for example, a processor, a controller, an arithmetic logic unit (ALU), a digital signal processor, a microcomputer, a field programmable gate array (FPGA), a programmable logic unit (PLU), a microprocessor, or one or more general-purpose computers or specific-purpose computers such as any other device capable of responding to and executing instructions in a defined manner. The processing device may run an operating system (OS) and one or more software applications that run on the OS. The processing device also may access, store, manipulate, process, and create data in response to execution of the software. For convenience of comprehension, the description of a processing device is used as singular; however, one of ordinary skill in the art will be appreciated that a processing device may include multiple processing elements and/or multiple types of processing elements. For example, a processing device may include multiple processors or a processor and a controller. In addition, different processing configurations are possible, such as a parallel processor.

The software may include a computer program, a code, an instruction, or a combination of one or more thereof, for independently or collectively instructing or configuring the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed manner. The software and data may be stored by one or more computer readable recording media.

The method according to the embodiments may be recorded in non-transitory computer-readable media including program instructions to implement various operations embodied by a computer. The computer-readable media may also include, alone or in combination with the program commands, data files, data structures, etc. The media and program instructions may be those specially designed and constructed for the purposes, or they may be of the kind well-known and available to those of skilled in the computer software arts. Examples of computer-readable media include magnetic media such as hard disks, floppy disks, and magnetic tape; optical media such as CD ROM disks and DVD; magneto-optical media such as floptical disks; and hardware devices that are specially to store and perform program commands, such as read-only memory (ROM), random access memory (RAM), flash memory, etc. Examples of the program commands may include machine language codes generated by a compiler and high-level language codes executable by an interpreter. The aforementioned hardware devices may be configured to operate as one or more software modules to carry out exemplary embodiments, and vice versa.

While the present disclosure has been described with reference to exemplary embodiments, one of ordinary skill in the art may practice various changes and modifications without departing from the spirit and scope of the present disclosure set forth throughout the annexed claim matters. For example, there may be attained a desired result according to the present disclosure even though the techniques are carried out through other methods and procedures different from the aforementioned, and/or even though the system, the structure, the units and the circuits are coupled in other manners different from the aforementioned, or substituted or replaced with other components or equivalents.

Therefore, other implementations, other embodiments, and equivalents of the claims are within the scope of the following claims.

The disclosure provides various methods of utilizing items in an in-game system through various embodiments, and thus, the user's desire to collect items may be aroused. Moreover, the reward with respect to the collected items is provided to the user, and thus, the user's desire for achievement may be aroused and an in-game play may be induced. Also, according to demands for collecting the items, transactions among the users may actively occur.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, performed by a game providing apparatus, of providing a game service, the method comprising:
based on a store request for storing an item retained by a user in an illustrated guide pool, transferring the item from an inventory of the user to the illustrated guide pool;
providing a reward to the user as the item is transferred to the illustrated guide pool;
based on a return request for returning the item stored in the illustrated guide pool to the inventory, transferring the item from the illustrated guide pool to the inventory of the user; and
retrieving the reward that has been provided to the user as the item is transferred to the inventory of the user.

2. The method of claim 1, wherein the store request is a request for collectively storing at least one item retained by the user in the illustrated guide pool.

3. The method of claim 1, wherein the return request is a request for collectively returning the at least one item stored in the illustrated guide pool to the inventory.

4. The method of claim 1, further comprising, based on all of items included in a preset item set being stored in the illustrated guide pool, providing the user with an additional reward.

5. The method of claim 1, further comprising, based on all of the items included in the preset item set being stored in the illustrated guide pool, displaying a character of the user, the character wearing the preset item set.

6. The method of claim 1, wherein at least one of the illustrated guide pool and the reward is shared by at least one character included in an account of the user.

7. The method of claim 1, wherein the reward is at least one of an ability parameter, game money, a reward item, illustrated guide points, and a change in display with respect to the items in the illustrated guide pool.

8. The method of claim 1, wherein the providing of the reward to the user comprises:
displaying illustrated guide points based on at least one item stored in the illustrated guide pool; and
providing the reward differently according to the illustrated guide points.

9. The method of claim 1, wherein the game includes a block chain game.

10. The method of claim 1, wherein the item includes a non-fungible token (NFT).

11. The method of claim 10, wherein the store request includes a request for staking the item.

12. The method of claim 10, wherein the return request includes a request for unstaking the item.

13. A game providing apparatus comprising:
a memory storing instructions; and
at least one processor functionally connected to the memory and configured to execute the instructions,
wherein the at least one processor is further configured to execute the instructions to,
based on a store request for storing an item retained by a user in an illustrated guide pool, transfer the item from an inventory of the user to the illustrated guide pool,
provide a reward to the user as the item is transferred to the illustrated guide pool,
based on a return request for returning the item stored in the illustrated guide pool to the inventory, transfer the item from the illustrated guide pool to the inventory of the user, and
retrieve the reward that has been provided to the user as the item is transferred to the inventory of the user.

14. The game providing apparatus of claim 13, wherein the store request is a request for collectively storing at least one item retained by the user in the illustrated guide pool.

15. The game providing apparatus of claim 13, wherein the return request is a request for returning the at least one item collectively stored in the illustrated guide pool to the inventory.

16. The game providing apparatus of claim 13, wherein the at least one processor is further configured to execute the instructions to, based on all of items included in a preset item set being stored in the illustrated guide pool, provide the user with an additional reward.

17. The game providing apparatus of claim 13, wherein the at least one processor is further configured to execute the instructions to, based on all of the items included in the preset item set being stored in the illustrated guide pool, display a character of the user, the character wearing the preset item set.

18. The game providing apparatus of claim 13, wherein at least one of the illustrated guide pool and the reward is shared by at least one character included in an account of the user.

19. The game providing apparatus of claim 13, wherein the reward is at least one of an ability parameter, game money, a reward item, illustrated guide points, and a change in display with respect to the items in the illustrated guide pool.

20. The game providing apparatus of claim 13, wherein the at least one processor is further configured to execute the instructions to, display illustrated guide points based on at least one item stored in the illustrated guide pool, and provide the reward differently according to the illustrated guide points.

21. The game providing apparatus of claim 13, wherein the game includes a block chain game.

22. The game providing apparatus of claim 13, wherein the item includes a non-fungible token (NFT).

23. The game providing apparatus of claim 22, wherein the store request includes a request for staking the item.

24. The game providing apparatus of claim 22, wherein the return request includes a request for unstaking the item.

25. A server comprising:
a memory storing instructions; and
at least one processor functionally connected to the memory and configured to execute the instructions,
wherein the at least one processor is further configured to execute the instructions to,
based on a store request for storing an item retained by a user in an illustrated guide pool, transfer the item from an inventory of the user to the illustrated guide pool,
provide a reward to the user as the item is transferred to the illustrated guide pool,
based on a return request for returning the item stored in the illustrated guide pool to the inventory, transfer the item from the illustrated guide pool to the inventory of the user, and
retrieve the reward that has been provided to the user as the item is transferred to the inventory of the user.

26. A user terminal comprising:
a memory storing instructions; and
at least one processor functionally connected to the memory and configured to execute the instructions,
wherein the at least one processor is further configured to execute the instructions to,
based on a store request for storing an item retained by a user in an illustrated guide pool, transfer the item from an inventory of the user to the illustrated guide pool,
provide a reward to the user as the item is transferred to the illustrated guide pool,
based on a return request for returning the item stored in the illustrated guide pool to the inventory, transfer the item from the illustrated guide pool to the inventory of the user, and
retrieve the reward that has been provided to the user as the item is transferred to the inventory of the user.

27. A non-transitory computer-readable recording medium having recorded thereon a program for executing, on a computer, the method of providing a game service of claim 1.

28. A method, performed by a game providing apparatus, of providing a game service, the method comprising:
based on a store request for storing an item retained by a user in an illustrated guide pool, transferring the item from an inventory of the user to the illustrated guide pool;
providing a reward to the user as the item is transferred to the illustrated guide pool; and
based on that all of items included in a preset item set are stored in the illustrated guide pool as the item is transferred to the illustrated guide pool, displaying a character of the user wearing a preset item set.

29. A method, performed by a game providing apparatus, of providing a game service, the method comprising:
based on a store request for storing a plurality of items retained by a user in an illustrated guide pool, transferring collectively the plurality of items from an inventory of the user to the illustrated guide pool; and
providing a reward to the user as the plurality of items are transferred to the illustrated guide pool collectively.
